(19) United States
(12) Patent Application Publication
(10) Pub. No.: US 2026/0221783 A1
(43) Pub. Date: Jul. 30, 2026

(54) CONTROL METHOD AND SYSTEM FOR IMPROVING POWER NETWORK STABILITY

(71) Applicant: LUXEMBOURG INSTITUTE OF SCIENCE AND TECHNOLOGY (LIST), Esch-sur-Alzette (LU)

(72) Inventors: Pedro RODRIGUEZ CORTES, Esch-sur-Alzette (LU); Nicholas Gregory BALTAS, Esch-sur-Alzette (LU)

(21) Appl. No.: 19/142,430

(22) PCT Filed: Dec. 18, 2023
(86) PCT No.: PCT/EP2023/086377

§ 371 Date: Jun. 23, 2025

(30) Foreign Application Priority Data
Dec. 23, 2022 (LU) LU503255

(51) Int. Cl. H02J 3/48; G05B 13/04; H02J 3/0014; H02J 3/36

(52) U.S. Cl. CPC H02J 3/48; G05B 13/042; H02J 3/0014; H02J 3/36; H02J 2003/365

(57) ABSTRACT

A control method and system is provided for power converters that are electrically interconnected through a power grid. The control mechanism uses a digital model of a mechanical shaft for emulating the electrical coupling between each pair of power converters. Power transfers computed using this multi-shaft model are applied at the corresponding power converters, which results in stable and disturbance-resilient power signals throughout the power network.

### TECHNICAL FIELD

The invention lies in the field of controlling power converters in electrical grids. In particular, the invention relates to a system and method for dynamically controlling the active power exchanged between coupled grid-connected power converters, electrically interconnected through a power grid

### BACKGROUND OF THE INVENTION

Interconnection of electrical areas in power systems is an essential issue due to economic and reliability-related reasons since such interconnection brings flexibility for optimizing power flows and allows sharing reserves to respond to potential contingencies in the system. Moreover, interconnection ensures that loads have multiple supply paths, thereby improving a supply reliability. Generally, electrical areas are interconnected though passive alternative current, AC, tie-lines since this is a cost-effective solution when the interconnected areas share the same nominal frequency and voltage and are geographically close each other. However, when areas with different nominal frequencies or voltages should be interconnected, or when the geographic distance between them is significant, power conversion stations are often required to actively interconnect such areas and to regulate power flows by using an AC-DC-AC power conversion configuration. Due to the ever-increasing demand, the rapid growth of renewable energy sources, and the advances in power conversion technologies, interconnection of power systems through power electronics-based active systems, such as multi-terminal high-voltage dc systems, MT-HVDC, has become an increasingly popular and effective interconnection solution in modern power systems.

As the heterogeneity and the capacity of power systems grows, their operational complexity also increases, which raises concerns regarding system stability, specifically dynamic stability in interconnected systems. One of the typical concerns regarding stability in large interconnected systems is the occurrence of sub-synchronous oscillations in tie-lines. Such power oscillations have been traditionally caused by the effect of long tie-lines, with high impedance, which could not be naturally damped by electromechanical generators, thus requiring the use of dedicated control systems. Even though such sub-synchronous oscillations have been studied for decades, they have undergone an increasing attention in recent years since they can be a consequence of the negative damping introduced by the control systems of large renewable power plants and power stations when interacting either with the electric grid or with other plants and stations.

The most widely used method to deal with sub-synchronous oscillation damping in interconnected power systems is the power system stabiliser, PSS, as explained in P. Kundur, “Power System Stability and Control”, McGraw-Hill Education, 1994 and G. Gurrala and I. Sen, “Power System Stabilizers Design for Interconnected Power Systems”, IEEE Trans. Power Syst., vol. 25, no. 2, pp. 1042-1051, May 2010, for example. Generally, the PSS takes the generator's frequency or power, or both, as input signals to calculate a reference signal for the generator's exciter. A PSS regulates the generator's instantaneous power injection to be perfectly synchronized with a given sub-synchronous grid oscillation to be attenuated. However, using a PSS is not a panacea since power oscillations generated by the interaction between power plant/station controllers, generally driven by power converters, are more likely to occur in the weaker ties, where PSSs have a minor presence and reduced damping contribution. Moreover, due to the complexity added by interconnections, choosing the optimal tuning parameters for the PSS's gain and compensation block is a complex task. In addition, the tuning of the PSS's parameters often discards the influence of network reconfiguration, making it less resilient to potential contingencies in the system.

Even though interconnected electrical areas in power systems benefit from one another in terms of load sharing and capacity reserve, they also share in the problems, so disturbances in an area may lead to voltage/frequency instabilities in other interconnected areas. Another concern is the widespread of blackouts in a large-scale interconnected system. In fact, the interconnection might facilitate the spread of severe transient disturbances from one area to its neighbours, leading to cascaded failures. Thus, stability of interconnected power systems with high share of renewable energy sources has become one of the most challenging requirements to be guaranteed by the system's operator. Guarantying stability of conventional interconnected power systems has accumulated tremendous efforts from academia and industry since the installation of the first power transmission systems. As an example, an islanded system as the one described in N. Senroy and G. T. Heydt, “A Conceptual Framework for the Controlled Islanding of Interconnected Power Systems”, IEEE Trans. Power Syst., vol. 21, no. 2, pp. 1005-1006, May 2006 can be used to electrically split an interconnected network into healthy areas and the faulty areas, avoiding the widespread propagation of severe disturbances. However, as the interconnected areas often support each other during disturbances thanks to their inertial nature, forcing system separation during disturbances might further worsen stability conditions in troubled areas. A potential remedy for such a problem as been proposed by improving the overall system damping, so that the probability for triggering instability during system's perturbations is reduced. Another known solution to avoid oscillations between interconnected systems is to reduce the impedance of long interconnection lines. For such purpose, a series capacitor has also been traditionally used to control the apparent line impedance and to thereby inherently increase the system damping.

Development of power electronics in the last decades have brought a gradual paradigm shift in solutions used for handling stability issues in interconnected power systems. Nowadays, the system's damping is not only provided by the PSS of synchronous generators or by passive solutions, but it is also provided by active units based on power electronics-based power converters. The main reason to such a paradigm shift is twofold: firstly, due to the increasing displacement of conventional synchronous generators, the suitable installation location for PSSs becomes fewer; and secondly, power electronics have become an omnipresent technology in the power system. In fact, power electronics are not only used at the load side, but also employed in power generation and transmission systems. Considering their high flexibility, it is apparent that power electronics-based power converters should also participate in enhancing the stability of the interconnected power systems.

In fact, PSS-like control schemes have been proposed for flexible AC transmission systems, FACTS, based on power converters to provide additional damping to oscillatory modes, see for example G. Cao, Z. Y. Dong, Y. Wang, P. Zhang, and Y. T. Oh, “VSC based STATCOM controller for damping multi-mode oscillations” in 2008 IEEE Power and Energy Society General Meeting—Conversion and Delivery of Electrical Energy in the 21st Century, 2008, pp. 1-8, or F. H. Gandoman et al., “Review of FACTS technologies and applications for power quality in smart grids with renewable energy systems”, Renew. Sustain. Energy Rev., vol. 82, pp. 502-514, February 2018. To optimize the performance of power converters in dealing with dynamic stability, more advanced control techniques have also been proposed in the literature. For instance, a robust controller based on linear quadratic gaussian controller to ensure a wider range of effective damping provided by the thyristor-controlled series compensator was presented in K. M. Son and J. K. Park, “On the robust LQG control of TCSC for damping power system oscillations”, IEEE Trans. Power Syst., vol. 15, no. 4, pp. 1306-1312, 2000. Similarly, a linear parameter varying method to improve transient stability of AC-DC interconnected power systems was investigated in Q. Hui, J. Yang, X. Yang, Z. Chen, Y. Li, and Y. Teng, “A robust control strategy to improve transient stability for AC-DC interconnected power system with windfarms”, CSEE J. Power Energy Syst., June 2019. The fact that these methods often require the full system model and a high level of mathematic manipulations to obtain the optimal gain hinders their actual deployment.

To address the drawbacks of the aforementioned methods, the concept of virtual synchronous machines, VSM, has been proposed for controlling power converters to provide grid-supporting functionalities H. P. Beck and R. Hesse, “Virtual synchronous machine” in 2007 9th International Conference on Electrical Power Quality and Utilisation, EPQU, 2007, pp. 1-6. Due to the simplicity and effectiveness of VSM, it has attracted much attention from the power systems community. The VSM control schemes are often employed to realize grid-supporting and grid-forming power converters. Basically, most of VSM control schemes are based on the emulation of an electromechanical synchronous generator. Therefore, most of the useful functionalities of a synchronous generator can be provided by a VSM. As the VSM is virtually implemented in a digital controller, all the parameters of the VSM can be tuned and adapted to the operating conditions to avoid some of the drawbacks often faced by conventional synchronous generators, such as low inherent damping. Furthermore, advanced functionalities can be included in the VSM framework with ease. For instance, multiple rotors can be simultaneously emulated in the VSM to provide selective damping to several target oscillatory modes.

From a physical perspective, the VSM enables power converters to have a virtual rotation frequency and inertia. Therefore, these type of VSM-controlled power converters may also be referred to as virtual rotating converters, VRC. Similar to a synchronous generator, a VRC can also provide frequency support for an electrical network in the event of disturbances, as explained for example in A. Tayyebi, D. GroB, A. Anta, F. Kupzog, and F. Dörfler, “Frequency stability of synchronous machines and grid-forming power converters”, arXiv, vol. 8, no. 2, pp. 1004-1018, 2020 and in W. Zhang, D. Remon, J. Rocabert, A. Luna, J. I. Candela, and P. Rodriguez, “Frequency support properties of the synchronous power control for grid-connected converters” ECCE 2016—IEEE Energy Convers. Congr. Expo. Proc., 2016. Recent works also confirmed that the inertia response produced by the VRC can also support neighbouring areas, see K. S. Skinder, T. Kerdphol, Y. Mitani, and D. Turschner, “Frequency Stability Assessment of Multiple Virtual Synchronous Generators for Interconnected Power Systems” IEEE Trans. Ind. Appl., vol. PP, no. c, pp. 1-1, 2021.

However, even though the above control techniques allow a VRC to provide frequency and voltage control support to the interconnected ac networks, each VRC in an interconnected network still operates independently according to its own tuning parameters. That is, each VRC controller is controlled by only considering its own electrical area, or more specifically, its own point of connection to the grid, rather than considering the interconnected system in which such a VRC is immersed. In fact, there is currently no method to dynamically coordinate the control of multiple VRCs to improve the dynamics and power flows in interconnected power systems beyond the well-known droop scheme. There is not yet any effective and well-accepted solution reported in the state of the art for controlling transient active power flows between interconnected VRCs or other power converters in face of grid events. Additionally, if the parameters of the VRC are not properly set, instabilities may occur even among VRCs interconnected in an electrical system due to control interactions. Consequently, there is a need for coordinating the control actions of all the interconnected power converters in a power network, in order to improve its coherent dynamic response and robustness in case of disturbances.

### Technical Problem to be Solved

It is an objective of the invention to present a method and system, which overcomes at least some of the disadvantages of the prior art.

### SUMMARY OF THE INVENTION

In accordance with a first aspect of the invention a control method for improving supply stability in a power network is provided. The power network electrically connects a first power converter to at least one second power converter through a power grid. The method comprises the steps of:
i) providing, for each pair of power converters composed of the first power converter and one of the second power converters, a digital shaft model of a mechanical shaft in a memory element, wherein said digital shaft model comprises a damping factor, an inertia and a stiffness of a mechanical shaft and emulates the electrical coupling between said pair of power converters through said power grid;
ii) obtaining, at a control unit, a pair of input signals from each of said pairs of power converters, wherein the input signals of a pair are indicative of rotating speeds applied to the ends of the corresponding digital shaft model;
iii) determining an active power deviation at the control unit, based on power transfers that are computed for each pair of power converters by applying a rotation equation to the corresponding digital shaft model using the corresponding pair of input signals;
iv) at the control unit, communicating a reference signal to the first power converter, which allows the first power converter to feed the active power deviation into the power grid or to absorb the active power deviation from the power grid, depending on the positivity of the active power deviation.

Preferably, the step of obtaining a pair of input signals may preferably comprise obtaining at least one signal indicating a rotating speed from at least one second power converter, wherein said second power converter emulates a mass rotating at said rotating speed.

The step of obtaining a pair of input signals comprises obtaining at least one measure of an AC grid frequency at the point of connection of at least one second power converter.

Preferably, step of obtaining a pair of input signals may comprise obtaining at least one measure of a DC voltage of a DC bus of at least one second power converter.

The reference signal may preferably comprise an indication of an electrical current intensity to be injected by the first power converter into the electrical grid.

Preferably, the first power converter may be controlled as a rotating mass, and said reference signal may comprise an indication of a load angle of the power converter.

It may be preferred that either the inertia or the stiffness, or both of the inertia and the stiffness of at least one digital shaft model may be set to zero.

In accordance with another aspect of the invention, a control unit is proposed. The control unit comprises
a memory element in which digital shaft models are stored, each digital shaft model comprising a damping factor, an inertia and a stiffness of a mechanical shaft configured to emulate the electrical coupling between pairs of power converters electrically connected through a power grid, wherein each pair of power converters is composed of the same first power converter and one second power converter;
receiving means configured to receive a pair of input signal from each of said pairs of power converters, wherein the input signals of a pair are indicative of rotating speeds applied to the ends of the corresponding digital shaft model;
   computing means configured to
      determine an active power deviation, based on power transfers that are computed for each pair of power converters by applying a rotation equation to the corresponding digital shaft model using a corresponding obtained pair of input signals;
      generate a reference signal, which allows the first power converter to feed the determined active power deviation into the power grid or to absorb the determined active power deviation from the power grid, depending on the positivity of the determined active power deviation;
transmission means configured to communicate said reference signal to the first power converter.

According to a further aspect of the invention, a control system for a power network is proposed. The control system comprises a plurality of control units in accordance with an aspect of the invention. Each control unit is configured to determine an active power deviation for one power converter of a plurality of power converters electrically interconnected through a power grid.

In accordance with yet another aspect of the invention, a power network in which a plurality of power converters are interconnected through a power grid is provided. The power network comprises at least one control unit in accordance with an aspect of the invention for controlling at least one power converter.

The power network may preferably comprise control system in accordance with an aspect of the invention.

According to another aspect of the invention, a computer program comprising computer readable code means is provided, which, when run on a computer system, causes the computer system to carry out the method according to an aspect of the invention.

In accordance with a final aspect of the invention, a computer program product comprising a computer readable medium is provided, on which the computer program according to an aspect of the invention is stored.

By using the proposed invention, it becomes possible to use a controller that digitally emulates an additional mechanical coupling between electrically interconnected power converters through virtual mechanical shafts. The proposed Virtual Multi-Shaft, VMS, controller and associated method for dynamically controlling active power exchanges among multiple power conversion stations physically interconnected in an electrical network sets additional virtual links that emulate the effect of mechanical shafts coupling the conversion stations in order to increase system damping and to reduce instability risk in case of disturbances. This method makes it possible to schedule dynamic active power flows among power conversion stations and to adjust the system's parameters in real-time to ensure proper damping levels in the system under generic operating conditions. The fundamental principle of the proposed controller is to adjust the dynamic power exchange between two or more coupled power conversion stations connected in an electrical grid so that they follow the natural power exchange that would occur between two equivalent masses coupled by a mechanical shaft. This fundamental operation principle is extended to multiple interconnected power conversion stations in a complete power system by emulating a set of virtual mechanical shafts coupling all the power stations of the network. The proposed method contributes to improve the dynamic stability of the electrical grid in case of disturbances and contingencies. The proposed controller and method are capable of dynamically controlling the active power exchanged between power conversion stations interconnected in an electrical grid, such that all the stations support each other during potential perturbations affecting to the system stability.

### BRIEF DESCRIPTION OF THE DRAWINGS

Several embodiments of the present invention are illustrated by way of figures, which do not limit the scope of the invention, wherein:

FIG. 1 shows a schematic illustration of a power system in accordance with a preferred embodiment of the invention, including a control unit in accordance with a preferred embodiment of the invention;

FIG. 2 shows a schematic illustration of a power system in accordance with a preferred embodiment of the invention, including a control unit in accordance with a preferred embodiment of the invention;

FIG. 3 shows a schematic illustration of a power system in accordance with a preferred embodiment of the invention, including a control unit in accordance with a preferred embodiment of the invention;

FIG. 4 provides an illustration of a digital shaft model used in preferred embodiments of the method in accordance with the invention;

FIG. 5 shows a schematic illustration of a power system in accordance with a preferred embodiment of the invention, including a control system in accordance with a preferred embodiment of the invention;

FIG. 6 provides a conceptual control diagram for a control system according to a preferred embodiment of the invention;

FIG. 7 provide a block diagram indicating main steps performed by a control system according to a preferred embodiment of the invention;

FIG. 8 illustrates a power network with three AC areas interconnected through both AC tie-lines and a multi-terminal HVCD network;

FIG. 9 illustrates the power network of FIG. 8, including digital shaft models;

FIG. 10 schematically illustrates a control diagram of an active power control loop of a power converter including a control unit according to a preferred embodiment of the invention;

FIGS. 11A, B and C provide plots of the dynamic frequency deviation in area 1, 2 and 3 of the power network shown in FIG. 8, wherein simulation results obtained using known methods and using a method according to a preferred embodiment of the invention are shown;

FIGS. 12A, B and C provide plots of the power flow deviation for different study cases of the power network shown in FIG. 8, wherein the results shown in FIGS. 12B and C are obtained using a method according to a preferred embodiment of the invention.

### DETAILED DESCRIPTION OF THE INVENTION

This section describes the invention in further detail based on preferred embodiments and on the figures. Similar reference numbers will be used to describe similar or the same concepts throughout different embodiments of the invention. For example, reference numerals 100, 200, 300, 400 each designate a control unit in accordance with the invention, but in different embodiments thereof.

It should be noted that features described for a specific embodiment described herein may be combined with the features of other embodiments unless the contrary is explicitly mentioned. Features commonly known in the art will not be explicitly mentioned for the sake of focusing on the features that are specific to the invention.

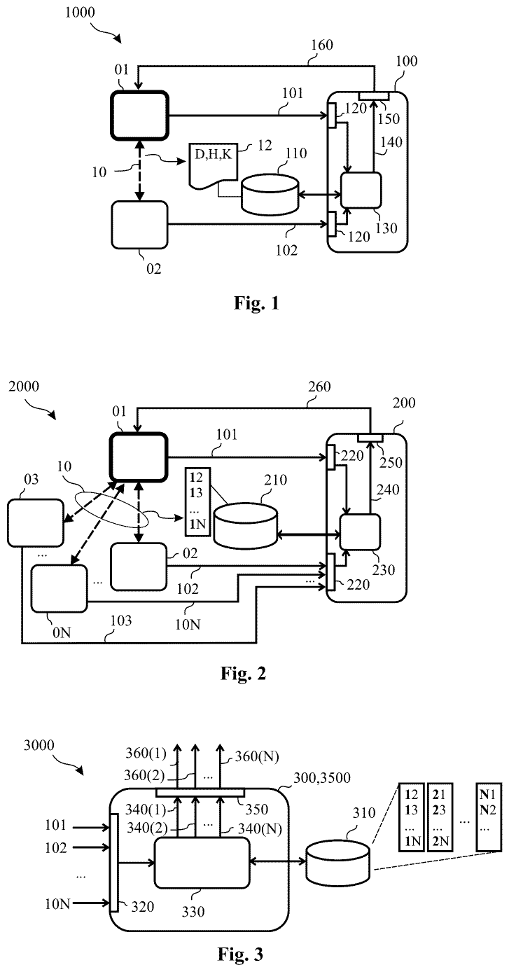

FIG. 1 illustrates a power network 1000 according to a preferred embodiment, in which a first power converter 01 is electrically interconnected with a second power converter 02 through a power grid 10. The power network 1000 comprises a control unit 100, which if configured to control the first power converter 01. In order to improve the supply stability in the power network, the control unit uses a method that relies on a digital shaft model 12, also called virtual shaft, which emulates a rotating mechanical shaft that would be used to transfer power between the first power converter 01 and the second power converter 02. The digital shaft model 12 is stored in a memory element 110 to which the control unit 100 has at least read access by means of its parameter values, describing an inertia H, a damping factor D and a stiffness K and corresponding motion equations. These parameters govern the behaviour of a mechanical shaft that interconnects two rotary masses with rotation frequencies ωᵢ and ωⱼ respectively, as illustrated in FIG. 4. The model parameters are chosen in dependence of a wanted target behaviour that the control method should achieve.

The digital shaft model 12 uses a pair of input signals received through appropriate receiving means 120 at the control unit 100, wherein the first input 101 is obtained from the first power converter 01, for example through a dedicated communication channel or through measurements in the power network, and wherein the second input 102 is obtained from the second power converter 02. The input signals 101, 102 are indicative of respective rotating speeds that are applied to the ends of the digital shaft model 12 that mimics the electrical connection between the two power converters 01 and 02. Depending on the type of power converter, the input rotary frequencies 101, 102 may be obtained through various measures. By way of non-limiting examples, the following cases may be considered:

If the power converter providing the input signal is an AC node, an estimate of the rotational speed applied to the corresponding end of the digital shaft model is provided by the grid frequency ω_{grid}. If the power converter providing the input signal is on a DC bus, an estimate of the rotational speed applied to the corresponding end of the digital shaft model is provided by measuring the DC bus voltage and computing:

$$\frac{1}{2} {J}_{i} {ω}_{i , shaf}^{2} = \frac{1}{2} {C}_{i} {V}_{dc \_ grid}^{2} .$$

If the power converter is internally controlled by a rotating shaft model, the rotational frequency of that model is provided as input signal at the corresponding end of the digital shaft model used by the control unit 100.

The control unit 100 comprises a processor 130 configured, for example through appropriately formulated software code instructions, to apply a rotation equation to the digital shaft model 12 by using the pair of input signals 101, 102 as inputs. Rotation equations for a mechanical shaft are for example provided in Equations (3) and (4) here below. As a result, an active power deviation 140 is obtained. If the resulting active power deviation is positive, this means that the first power converter 01 should inject correspondingly more power into the power grid 10 to stabilize the power signal on its link to the second power converter 02. If the resulting active power deviation is negative, the first power converter should absorb the corresponding power. Using appropriate transmission means 150, a reference signal 160 for controlling the first power converter 01 is therefore communicated to the first power converter 01. Once the reference signal 160 is received, the first power converter 01 implements the corresponding determined active power deviation 140. The reference signal 160 may, by way of a non-limiting example, communicate an amount of electrical current which the first power converter 01 should inject into the power grid, in order to deliver the determined active power deviation 140 p_{shaft}. The corresponding electrical current may for example be computed by

$${i}_{grid} = \frac{v}{{\vert v \vert}^{2}} {p}_{s haft} .$$

If the power converter 01 is itself controlled using a mechanical shaft model, the reference signal 160 may provide the load angle:

$$δ = {sin}^{- 1} ( \frac{{X}_{link}}{{V}_{grid} {E}_{r o t o r}} {p}_{s haft} ) .$$

FIG. 2 illustrates a power network 2000 according to a preferred embodiment, in which a first power converter 01 is electrically interconnected with a plurality of second power converters 02, 03, . . . 0N, where N is an integer, through a power grid 10. The overall functioning is similar as for the power network described in the context of FIG. 1. The power network 2000 comprises a control unit 200, which if configured to control the first power converter 01. In order to improve the supply stability in the power network, the control unit uses a method that relies on digital shaft models 12, 13, . . . 1N also called virtual shafts. A digital shaft model emulates a rotating mechanical shaft that would be used to transfer power between the first power converter 01 and each one of the second power converters 02, 03, . . . , 0N respectively. The digital shaft models 12, 13, . . . , 1N are stored in a memory element 210 to which the control unit 200 has at least read access by means of its parameter values, describing an inertia H, a damping factor D and a stiffness K and corresponding motion equations for each digital shaft model. These parameters govern the behaviour of a mechanical shaft that interconnects two rotary masses with rotation frequencies ωᵢ and ωⱼ respectively, as illustrated in FIG. 4. The model parameters are chosen in dependence of a wanted target behaviour that the control method should achieve.

Each digital shaft model 12, 13, . . . , 1N uses a pair of input signals received through appropriate receiving means 220 at the control unit 200, wherein the first input signal 101 of each pair is obtained from the first power converter 01, and wherein the second input signal of a given pair 102, 103, . . . , 10N is obtained from a respective one of the second power converters 02, 03, . . . , 0N. The input signals 101, 102, 103, . . . , 10N are indicative of respective rotating speeds that are applied to the ends of the digital shaft models 12, 13, . . . , 1N that mimic the electrical connections between the two power converters 01 and 02, the two power converters 01 and 03, up to the two power converters 01 and 0N respectively

The control unit 200 comprises a processor 230 configured, for example through appropriately formulated software code instructions, to apply a rotation equation to each digital shaft model 12, 13, . . . , 1N by using the corresponding pairs of input signals (101,102), (101,103), . . . , (101,10N) as inputs. Rotation equations for a mechanical shaft are for example provided in Equations (3) and (4) here below. The resulting partial power deviations per digital shaft model are preferably summed up to obtain an active power deviation 240. Using appropriate transmission means 250, a reference signal 260 for controlling the first power converter 01 is then communicated to the first power converter 01. Once the reference signal 260 is received, the first power converter 01 implements the corresponding determined active power deviation 240.

FIG. 3 illustrates a detail of a power network 4000 according to a preferred embodiment, in which a plurality of non-illustrated power converters is electrically interconnected through a power grid. The overall functioning is similar as for the power network described in the context of FIGS. 1 and 2. The power network 2000 comprises a control unit 300, which if configured to control a plurality of N power converters. As such it may be considered as a control system comprising a plurality of control units that are each similar to the control units as previously described in the context of FIGS. 1 and 2 respectively. The control system may be implemented in a distributed way in the power network without leaving the scope of the present invention. In order to improve the supply stability in the power network, the control unit 300 uses a method that relies on digital shaft models 12,13, . . . 1N also called virtual shaft for determining, as previously described, an active power deviation 340(1) for controlling power converter 01, which is communicated through transmission means 350 to the power converter 01 by the corresponding reference signal 360(1). The control unit 300 uses the same method for controlling the power converter 02: the memory element 310 also comprises digital shaft models 21, 23, . . . , 2N for each electrical connection that links the power converter 02 to the power converters 01, . . . 0N, and so forth. By applying the corresponding rotation equations and the corresponding input signals 101, 102, . . . , 10N, the control unit 300 determines the active power deviations 340(2), . . . , 340(N) that are to be applied at the corresponding power converters 02, . . . , 0N in order to improve the power signal stability in the power network 3000. The corresponding determined active power deviations are communicated to the power converters 02, . . . , 0N by reference signals 360(2), . . . , 360(N) respectively, similarly to what has been previously described in the context of FIG. 2, which deals with the control signal for power converter 01.

In all embodiments, the obtention of input signals 101, 102, . . . , 10N at the control unit 100, 200, 300 may comprise pre-filtering steps, in which measures obtained from the corresponding power converters are transformed into rotation frequencies for corresponding digital shaft models, as previously discussed. Further, the control method may only be applied based on a filter that selects a predetermined rotation frequency range and an attenuation factor. Optionally, a discriminator may be used for selecting time periods in which the input signals are indeed used to control the power converters.

Similarly, before transmitting the reference signals 160, 260, 360, the control unit may be configured to select a frequency range and an attenuation factor for the active power deviation 140, 260, 360 to be delivered by the corresponding power converter. If the determined active power deviations outside of a predetermined range, they are discarded. Further optionally, a discriminator may be used for selecting the time periods when the reference signals should be implemented at the corresponding power converters.

In what follows, further preferred embodiments of the invention will be described to highlight specific features and to provide further explanations, without limiting the scope of the invention to these embodiments.

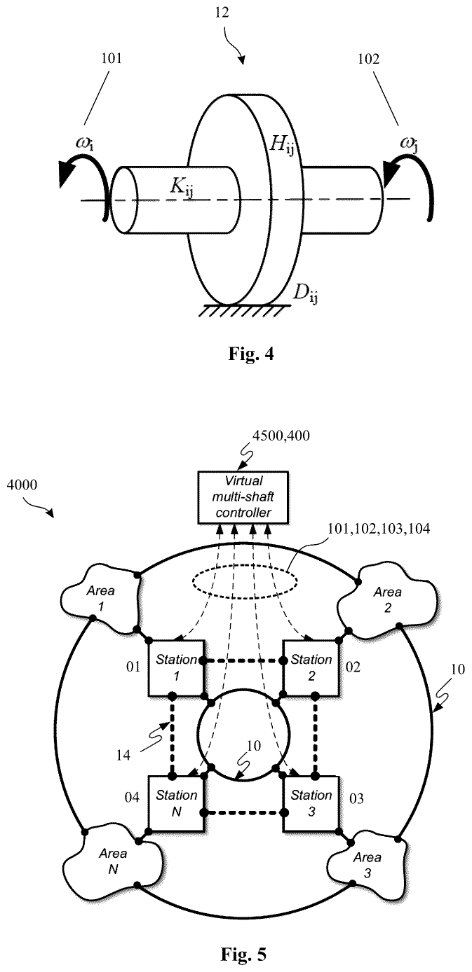

FIG. 5 shows the conceptual representation of a set of electrical areas/sections of a power network 4000 in accordance with a preferred embodiment of the invention, which may be potentially interconnected 10 with each other by passive tie-lines, if they have compatible voltage and frequency levels. In case that the nominal voltage and frequency of the electrical areas differ from one another, their interconnection should be conducted by using other active methods different to simple tie-lines. Some grid-connected power conversion stations 01, 02, 03, 04, are connected in such electrical areas. Such conversion stations may have several power conversion ports, thus they may be potentially interconnected through a dedicated active interconnection network, as in the case of a high-voltage dc (HVDC) system. In such a case, the power conversion stations would transform the area's native magnitudes, like voltage and frequency, into the common electrical magnitudes of the active interconnection network such that the active power exchange between the areas is possible. The main objective of the control system 4500 using control units 400 in accordance with the invention as previously described, also referred to as a VMS controller, is to dynamically control the active power exchange between power conversion stations of a grid 10 by emulating the physical effect of mechanical shafts coupling such power conversion stations, as exemplified by the link 14. The VMS controller 4500 uses a set of state inputs 101, 102, 103, 104 to generate an active power deviation reference signal, for each of the coupled power conversion stations. It should be noted that the dynamic power exchange managed by the VMS controller to emulate the effect of the virtual mechanical shafts is also possible when there is no dedicated network interconnecting the power conversion stations. However, each station must have a power system connected to one of its ports to satisfy the active power exchanges set by the VMS controller.

In this embodiment, the power conversion stations are assumed to be power electronics-based power converters. The low-level controllers in each power conversion could be based on any existing control technique. In case the power converters used in the stations are based on the virtual synchronous machine, VSM, techniques, they are referred to as virtually rotation converters, (VRC), in what follows. This is because a power converter controlled by a VSM technique emulates a virtual mass rotating at a synchronous frequency. Under this approach, a conventional grid-following converter could be understood as a VRC with zero inertia.

The objective of the VMS controller 4500, 400 is to enable dynamic control of the power exchanged between interconnected VRCs, or equivalently, power converters 01, 02, 03, 04. That is, the VMS controller reinforces the natural electrical link provided by the electrical grid to contribute into the attenuation of instantaneous angular frequency deviations of the coupled VRCs from their nominal value, despite the fact that the value of the nominal frequency of the interconnected areas may be different from each other, as occurs when asynchronous ac areas are connected through a DC link. Therefore, in case of a transient deviation in the frequencies of the system as a consequence of a perturbation, a transient power exchange between virtually coupled power conversion stations will happen according to the mechanical characteristics of the virtual shafts connecting such stations to minimize the impact of such perturbation in the dynamic stability of the system.

The VMS controller perceives each power conversion station of the interconnected electrical system as a virtual rotating mass. The normalized virtual rotating frequencies of each couple of VRCs are used as input signals for the VMS controller to calculate the instantaneous active power references for such VRCs. Thus, at the system level, the VMS controller emulates a complex virtual mechanical system whose virtual rotating masses are coupled through multiple virtual mechanical shafts. These virtual mechanical shafts will have no effect in the case that all VRCs remain synchronized. However, as soon as a deviation happens among their rotating frequencies, the effect of the virtual shafts emulated in the VMS controller will result in a dynamic power exchange between the power conversion stations, which will depend on the mechanical parameters of such virtual axes.

The basic operating principle of the VMS controller stems from the mechanical connection between two rotating masses. FIG. 4 illustrates the conceptual representation of such mechanical system. when connecting the i^{th} and j^{th} rotating masses. In this illustration, the masses are assumed to rotate at angular frequency of ωᵢ and ωⱼ. These two masses are connected by a virtual mechanical shaft, which is characterized by its mechanical parameters, namely, the damping Dᵢⱼ, the stiffness Kᵢⱼ, and the inertia Hᵢⱼ coefficients. These three mechanical parameters of the shaft determine the dynamic power exchange between the two virtually interconnected rotating masses, which will match the instantaneous active power exchanged between the two virtually coupled power conversion stations. The dynamic behaviour of this mechanical system can be described in terms of transferred power through the well-known rotational motion equation, which is mathematically described by equations (3) and (4), as presented further below.

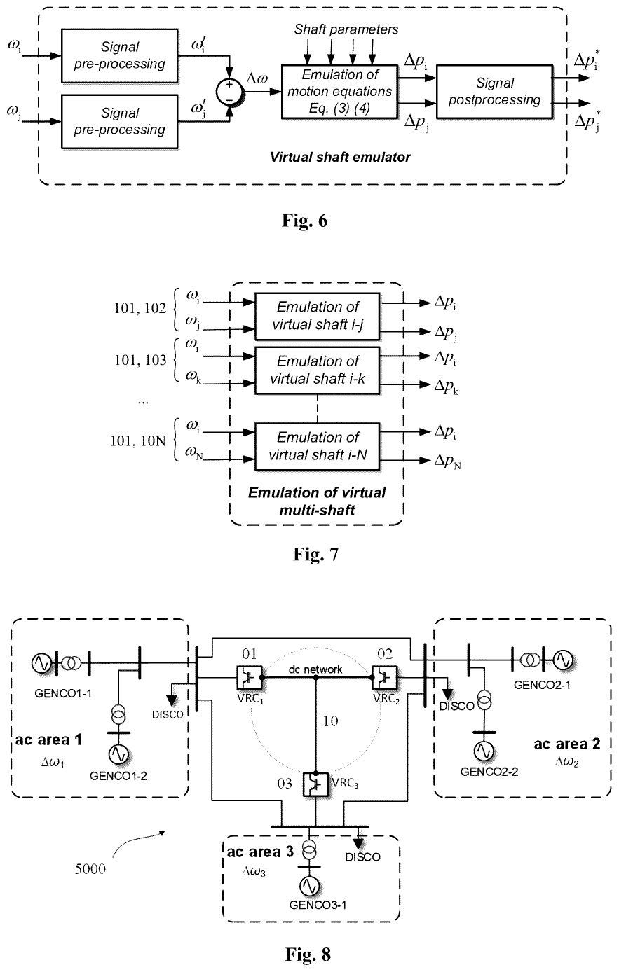

FIG. 6 shows the conceptual control diagram of a virtual shaft emulator or control unit used in this embodiment, that interconnects two grid-connected power conversion stations. The virtual shaft emulator receives the virtual rotary frequencies of the two coupled power conversion stations as input signals (ωᵢ and ωⱼ). However, as will be discussed later, the input signals to this emulator might not represent virtual rotary frequencies, but rather any other state signals representing magnitudes that could be transformed into normalized virtual rotary frequencies (ωᵢ′ and ωⱼ′) by the emulator's signal pre-processing stages. In fact, this signal pre-processing stage properly prepares and conditions the signals received from the virtually coupled power conversion stations, so that they are in the proper form to be processed in the emulation of the rotational motion equation block. Furthermore, a post-processing block, prepares the output actuation signal of the virtual shaft emulator according to the specifications set by the power conversion stations. As an example of the post-processing block functionality in a particular implementation of the virtual shaft emulator, the actuation signal might be only generated in case of specific transient events or for specific frequency ranges.

As indicated above, the active power deviation to be transferred by an elastic mechanical shaft that couples two rotary masses can be calculated through the rotational motion equations, which are given here below by way of a non-limiting example in Equations (3) and (4). The value for the mechanical parameters of the virtual shaft could be changed at any time according to the application requirements. However, in a particular implementation of the virtual shaft emulator, the block in charge of computing the rotational motion equations linking two coupled power conversion stations could implement more complex equations than the ones shown in (3) and (4), since this block might emulate, for instance, the action of several coupling shafts working in parallel, whose individual parameters could be adjusted as a function of the operating conditions, or only used for specific frequency ranges.

The output signals of the rotational motion emulation block of FIG. 6 determine the instantaneous active power deviations to be exchanged between the two coupled power conversion stations, Δpᵢ and Δpⱼ. This output signals are post-processed in a dedicated postprocessing block to generate the reference signals sent to the coupled power stations, Δp*ᵢ and Δp*ⱼ. Through this block, the output signals of the virtual shaft emulator can be adapted to the requirements imposed by the internal controller of the coupled power conversion stations, and to the limitations imposed by the technology of the power converters and by the interconnection network.

The output signals of the virtual shaft emulation block shown in FIG. 6 are provided as additional inputs to the system in charge of setting the operational power flow between two coupled power conversion stations.

In a generic power grid, where multiple power conversion stations can be virtually cross-coupled, the VMS controller can be implemented by setting several virtual mechanical shaft emulators, which virtually cross-couple all the conversion stations of the grid. A simplified diagram of the VMS system or control unit is shown in FIG. 7, in which it can be seen how the virtual rotary frequencies of the coupled power conversion stations are all used as input signals 101, 102, . . . , 10N, and how the output signals, representing the instantaneous active power deviations to be exchanged by each pair of coupled stations, are generated by corresponding virtual shaft emulation blocks. These power references dynamically regulate the active power to be exchanged among the power conversion units of the grid to improve its overall dynamic stability thanks to the damping effect provided by the set of virtual shafts.

In case the coupled power conversion stations are driven by virtual synchronous machine controllers, the VMS controller can easily regulate the active power exchanged between such power conversion stations by simply using their virtual rotary frequencies (ωᵢ, ωⱼ) as inputs signals for the virtual shaft emulation block shown in FIG. 6. However, the VMS controller also works properly in case the coupled power conversion stations are controlled by any other type of conventional controller, such a grid following controllers, which do not emulate a rotary mass with a virtual rotary frequency but estimate the frequency and/or phase angle of the AC voltage of the point of connection to the grid. In such a case, the VMS controller pre-processes the estimated grid frequency at the point of connection of the power conversion station and translates it into a corresponding normalized virtual frequency. From there, the VMS controller determines the active power to be transferred through the virtual shafts. In case the area to be coupled to the interconnection network through a power conversion station works in dc, the VMS controller will use the pre-processing blocks for estimating an equivalent virtual rotary frequency from other suitable energy state signal sent by the power conversion station, for example from the DC-bus voltage.

In this way, the VMS controller can regulate the dynamic active power exchanged among several areas linked to an interconnection network through different types of power conversion stations to minimize the impact of disturbances and contingencies on the system stability.

A further preferred embodiment of this invention is described with illustrative drawings from FIG. 8 to FIG. 12.

The power system used to present the following preferred embodiment of the VMS controller (control unit) and method is shown in FIG. 8, where three AC areas are interconnected 10 through both passive tie-lines and a multi-terminal HVDC (MT-HVDC) network coupled through power conversion stations 01, 02, 03, which will also be referred to as VRC₁, VRC₂ and VRC₃ respectively. Each AC area of the power system may consist of multiple synchronous generators. However, for the sake of simplifying explanations, aggregated models are used to simulate the AC areas of the system. In this manner, Area 1 and Area 2 consist of two generation companies (GENCO) with synchronous generators, whereas Area 3 has only one GENCO with a synchronous generator. Parameters of the three AC areas are provided in Table I. Similarly, the aggregated load of each area is represented as manged by a distribution company (DISCO). The AC-DC power conversion stations of the interconnection MT-HVDC network are controlled as virtual rotating converters (VRCs) by using a virtual synchronous machine (VSM) controller. In particular, the synchronous power controller (SPC) is used to control the VRCs in this embodiment. The virtual multi-shaft (VMS) controller sends active power deviation references to the three AC-DC power conversion stations of the MT-HVDC network to damp frequency oscillations in the system.

TABLE I

| | Area 1 | | Area 2 | | Area 3 |
|---|---|---|---|---|---|
| Parameters | GENCO1-1 | GENCO1-2 | GENCO2-1 | GENCO2-2 | GENCO3-1 |
| Turbine time | 0.325 | 0.30 | 0.32 | 0.32 | 0.32 |
| constant (s) | | | | | |
| Governor time | 0.070 | 0.060 | 0.075 | 0.075 | 0.065 |
| constant (s) | | | | | |
| Governor droop | 2.45 | 2.55 | 2.70 | 2.70 | 2.45 |
| (Hz/pu) | | | | | |

Controlling the frequency in each area of the interconnected system is a crucial issue to guarantee dynamic stability during load/generation variations and contingencies. System operators use different frequency control schemes, with different time scales, to keep the area frequency close to its nominal value. In general, frequency regulation for a given area is accomplished through a power-frequency control scheme, typically implemented through primary and secondary controllers. Such control scheme provides a set of primary references for generation stations in the area based on local frequency measurements, while a central supervisory controller provides a set of secondary references to all the generation stations in the area based on the calculation of the area control error (ACE).

To simulate the dynamic frequency response of the power system shown in FIG. 8, it is assumed that the frequency deviation of the i^{th} area of the system (i=1, 2, 3) is given by the simplified equation shown in (1).

$$Δ {ω}_{i} = \frac{{K}_{pi}}{1 + {sT}_{pi}} ( Δ {P}_{Gi} - Δ {P}_{Li} + Δ {P}_{exch , i} ) , \qquad ( 1 )$$

where the damping and inertia for the simplified i^{th} AC area are modelled through the gain Kₚᵢ and the time constant Tₚᵢ, respectively. The term ΔP_{Gi} denotes the net deviation of the power generated by the generation companies (GENCO) in the i^{th} AC area, represents the term ΔP_{Li} is the total load deviation (DISCO) in the i^{th} AC area, and ΔP_{exch,i} represents the net deviation of the power exchanged by the i^{th} area through all its passive ac tie-lines (ΔP_{tieAc,i}) and by the link to the MT-HVDC system (ΔP_{tieDC,i}).

To describe in detail the behaviour of this preferred implementation of the VMS controller, a comparison of the dynamic frequency response in the electrical areas of the power system is shown in FIG. 8 when a load step occurs in Area 1, considering three interconnection cases between the electrical areas, which are: i) the electrical areas are interconnected by using only passive AC tie-lines, ii) the electrical areas are interconnected by using both passive ac tie-lines and a MT-HVDC network controlled by a conventional proportional control scheme, iii) the electrical areas are interconnected by using both passive ac tie-lines and a MT-HVDC network controlled by the VMS controller.

In a known conventional control method, used as a baseline in what follows, a conventional proportional controller is used to control the power conversion stations of a HVDC link that interconnects two AC areas of a power system, i.e., the i^{th} and the k^{th} AC areas, which are additionally interconnected through a passive AC tie-line. The input signals for such a proportional controller are the frequency deviations for the i^{th} and the k^{th} ac areas (Δωᵢ and Δωₖ) and the power flow deviation in the ac tie-line linking both ac areas (ΔP_{tieAc,ik}). The output signal from the proportional controller is used to generate the active power reference signal (ΔP*_{tieAC,ik}) for the power conversion station that couple the i^{th} AC area to the HVDC link. Therefore, the active power reference signal for the i^{th} power conversion station (ΔP*_{tieAc,ik}) of the HVDC interconnection system can be written as:

$$Δ {P}_{tieAC , ik}^{*} = {K}_{i} {Δω}_{i} + {K}_{AC} Δ {P}_{tieAC , ik} + {K}_{k} {Δω}_{k} , \qquad ( 2 )$$

where Kᵢ is the proportional gain to compensate the frequency deviation in the i^{th} area, Kₖ is the proportional gain to compensate the frequency deviation in the k^{th} area, and K_{AC} is the proportional gain to compensate the power flow deviation in the ac tie-line interconnecting the i^{th} and k^{th} AC areas. In order to keep a balanced power flow, the active power reference, but with negative sign, will be provided as a reference to control the AC-DC power conversion station coupling the kth ac area to the HVDC link. This control scheme, as a baseline scheme, is extended to all the power conversion stations and interconnections of the MT-HVDC network shown in FIG. 8 to control the dynamic frequency response in such an interconnected power system.

It is worth mentioning that the small-signal dynamic response of the HVDC link is modelled as a first-order transfer function, with a time constant T_{DC}. Moreover, it should be highlighted that the internal controllers of the power conversion stations considered in this preferred use case are based on the SPC, so they naturally behave as VRCs. This particular implementation of the local-level power converter controller is very convenient to present the preferred implementation of the system-level VMS controller, since as each VRC has a virtual rotational speed, which must be perfectly synchronized with the frequency of the AC areas in steady-state, it allows understanding intuitively that several of these power conversion stations could be virtually coupled through the mechanical axes emulated by the VMS controller.

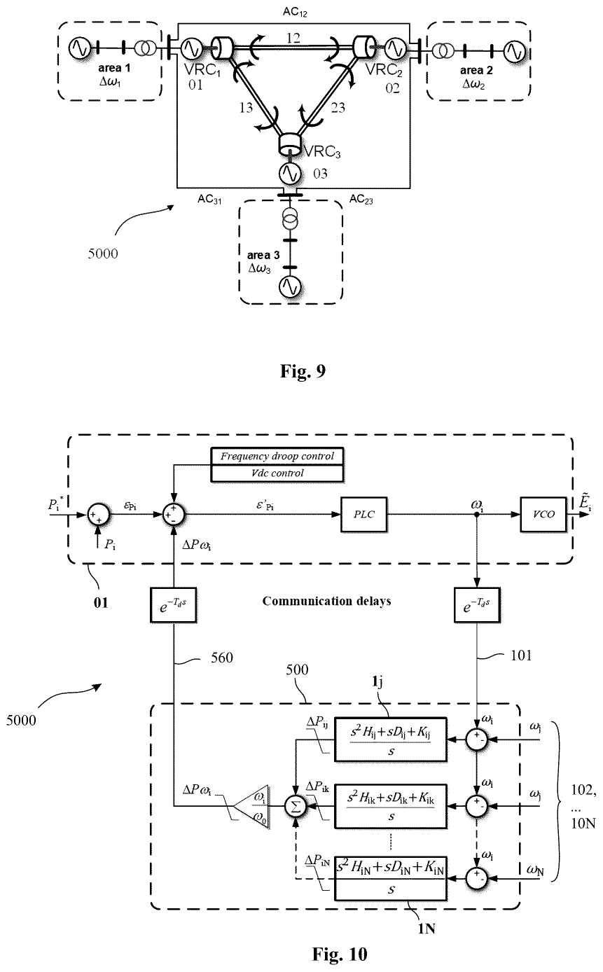

FIG. 9 describes in a symbolic way some of the virtual mechanical coupling between the power conversion stations 01, 02, and 03 (VRC₁, VRC₂ and VRC₃) of FIG. 8. In this figure, it can be seen how the VMS controller is a multi-input multi-output system that calculates in real-time the instantaneous active power deviations to be transferred through each of the virtual shafts coupling power conversion stations controlled as VRC in case of deviations in their rotational frequencies. However, it is worthy to remind that the VMS controller could also be used to regulate the power exchanged between power conversion stations based on classical control schemes, such as the ones used in grid-following power converters, since a virtual rotation speed might be generated from the measurement of the AC grid frequency, e.g., by using a well-known phase locked loop, PLL, or the energy status of the converter as input variables for the signal pre-processing.

For this preferred embodiment of the VMS controller, the motion equations determining the power transferred from each of the ends of a shaft joining the i^{th} and j^{th} VRCs of FIG. 9, with i, j=1, 2, 3, can be expressed in per unit as.

$$Δ {P}_{i} = ( 2 {H}_{ij} s + {D}_{ij} + \frac{{K}_{ij}}{s} ) ( {ω}_{i} - {ω}_{j} ) \frac{{ω}_{i}}{{ω}_{0}} , \qquad ( 3 )$$

$$Δ {P}_{j} = ( 2 {H}_{ji} s + {D}_{ji} + \frac{{K}_{ji}}{s} ) ( {ω}_{j} - {ω}_{i} ) \frac{{ω}_{j}}{{ω}_{0}} , \qquad ( 4 )$$

where ωᵢ and ωᵢ are the virtual angular frequencies of the i^{th} and j^{th} power conversion stations, ω₀ is the nominal frequency used for normalization (typically the AC grid frequency) and Hᵢⱼ, Dᵢⱼ and Kᵢⱼ are the inertia constant, the stiffness and damping factor of the virtual shaft, respectively. Normally, a virtual shaft will have a symmetric performance, that is, Hᵢⱼ=Hⱼᵢ, Kᵢⱼ=Kⱼᵢ and Dᵢⱼ=Dⱼᵢ, although such symmetry can be modified if necessary.

Equations (3) and (4) are the typical motion equations of an elastic shaft, which are used in the VMS controller to determine the power to be transferred between two coupled VRCs. It should be noted that the power transferred from the i^{th} end of a given shaft does not necessarily coincide with the power transferred from the k^{th} end, due precisely to the power losses and elastic behaviour of the emulated mechanical shaft. Precisely, by properly selecting the mechanical parameters of the virtual axes of the VMS controller, it is not only possible to help all the VRCs in the network to rotate with the same frequency in steady state, but it will also allow changing the natural response of the system to improve its dynamic stability.

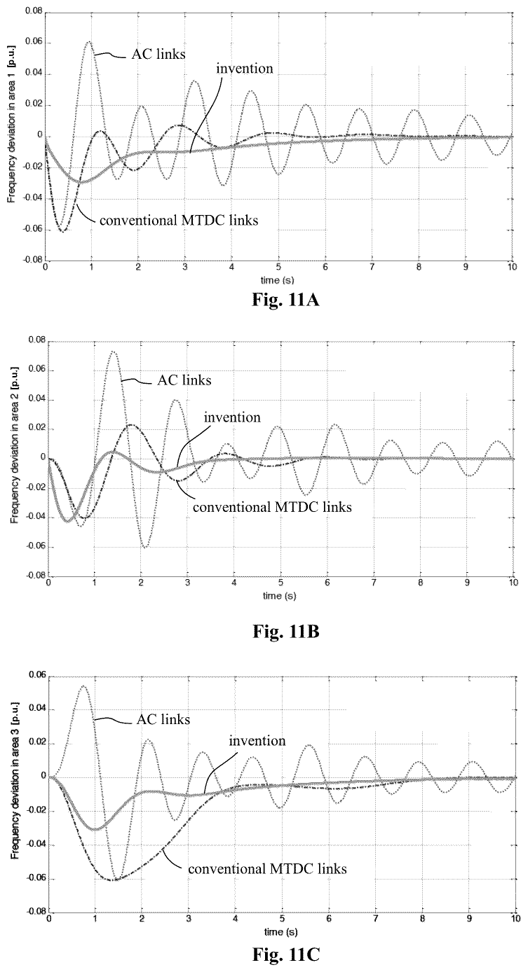

To implement a set of cross-coupling shafts in a generic interconnected network with multiple power conversion stations, the VMS controller will receive the frequencies of all the coupled VRCs (i.e., power converters) (ω₁, ω₂ . . . ω_{N}) as input signals, and compute the dynamic equations of the different coupling virtual axes to determine the power reference to be sent to each of them. FIG. 10 shows the implementation of the VMS controller for the i^{th} power conversion station of the system in FIG. 9, with i, j, k=1, 2, 3.

As shown in FIG. 10, this scheme can be extended to a number of N stations by simply adding more motion equations to the VMS controller, corresponding to the additional shafts of the system. Considering for example i=1, FIG. 10 shows the control unit 500 in the power network 5000, for controlling power converter 01. The input provided at the control unit 500 includes input signals 101 (from power convert 01) and input signals 102, . . . , 10N from the 2-N power converters that are electrically interconnected with the power convert 01 through a grid. Based on the input signals and the corresponding digital shaft models, of which one is indicates with reference 1j, a reference signal 560 is generated.

Therefore, each power conversion station in the interconnected system will receive from the VMS controller 500 a corresponding reference signal 560 to modify its active power, which will aggregate the individual contribution of all the virtual shafts that couple such power conversion station with the rest of stations in the system. There are multiple techniques that can be used to select the value of the virtual shaft parameters of the system, e.g., eigenvalue positioning from small signal analysis, frequency analysis for harmonic oscillations attenuation, passivity-based analysis, data-driven analysis, etc. In any case, these parameters can be modified in real-time to adapt the VMS controller to the operating conditions of the system at any time. It should be mentioned that the delays introduced by the communication systems between the local controllers of the VRCs and the system-level VMS controller affect the dynamic response of the system and must be considered when selecting the value of the virtual axis parameters.

Since the internal controllers of the power conversion stations in this preferred implementation are based on the SPC, FIG. 10 shows the power loop controller, PLC, and voltage-controlled oscillator, VCO, blocks of the SPC. Likewise, a block for the droop and DC voltage controllers of the power converter is also shown in FIG. 10. As already indicated above, the internal controller of the power conversion stations 01,02,03, and 04 could be based on any other control method for grid-connected converters than SPC. In such a case, the virtual rotating frequency used as an input to the VMS controller would be obtained from any other relevant magnitude of the power converter, e.g., from the grid frequency estimated by a PLL. It should be noted here that whereas the VMS controller depicted in FIG. 10 generates active power reference signals 560 for the power conversion stations of the interconnected system, any other signal might be also used to control the power flow of the converter stations, e.g., an active current reference or virtual rotational frequency reference. It should be also mentioned that the power reference generated by the VMS controller must take into account the inherent limitations of the power conversion stations, e.g., in terms of current or voltage limitations on the dc bus to ensure safe system operation.

In order to illustrate the effectiveness of the VMS controller respect to other existing solutions, some simulation results are presented in the following when used in the actively interconnected system shown in FIG. 8.

FIGS. 11A-C respectively present the dynamic frequency response in the respective three areas of the interconnected system of FIG. 8 under an event of load connection of 0.03 p.u. in Area 1. To evaluate the impact of the VMS controller on the frequency response of the three interconnected areas of the system, the following interconnection cases and controllers are considered:
i) electrical ac areas interconnected through only passive AC tie-lines (AC links);
ii) electrical ac areas interconnected through both passive AC tie-lines and a MT-HVDC network with power conversion stations controlled by the described conventional system-level proportional control scheme (conventional MTDC links)
iii) electrical ac areas interconnected through both passive AC tie-lines and a MT-HVDC network with power conversion stations controlled by the control scheme shown in FIG. 10, which includes the system-level VMS controller or control unit in accordance with a preferred embodiment of the invention (invention).

The results shown in FIGS. 11A-C evidence the positive impact of the proposed VMS controller in improving frequency stability and power distribution in the interconnected electrical areas in the event of disturbances. Indeed, the VMS improves significantly the dynamic performance of system, damping frequency oscillations in a more effective manner than in the case of using only passive ac tie-lines and a MT-HVDC system driven by a conventional system-level proportional controller, which eventually contributed to improve the dynamic stability of the system. The figures show how the VMS controller is able to significantly damp transient frequency oscillations after the first swing of the system, while the conventional proportional controller takes more time to attenuate such oscillations, which also have higher amplitude compared to the case of the VMS controller.

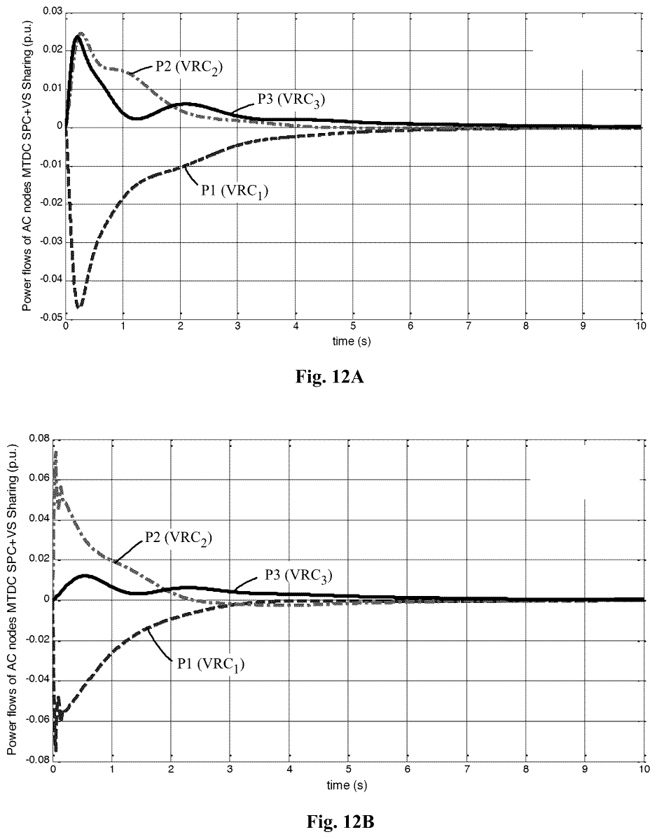

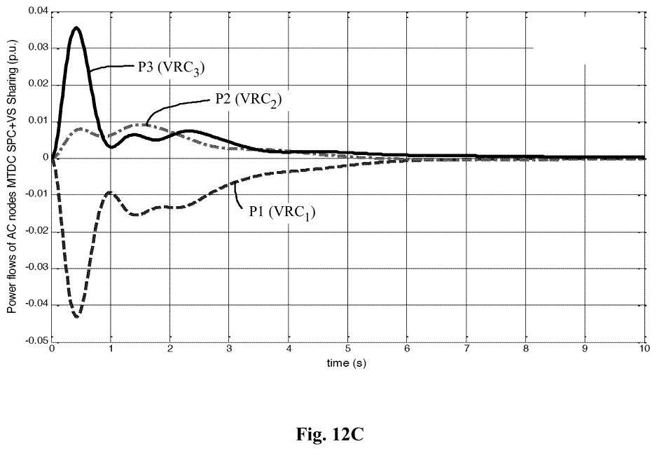

To evaluate the ability of the VMS controller to modulate the strength of dynamic support between coupled power stations, which allows to dynamically regulate the dynamic capacity that each power conversion station offers to the rest of virtually coupled stations in case the system is affected by a disturbance, three studies cases are analysed on the interconnected system of FIG. 8 and results are shown in FIGS. 12A-C.

In this manner, Case A studies the dynamic power flow between the AC areas of FIG. 8 when the MT-HVDC system is controlled through the described conventional high-level proportional scheme. The simulation results for Case A are shown in FIG. 12A. In the second and third case study, i.e., in Case B and Case C, the VMS controller or control unit according to the invention is used to dynamically control the power exchanged between electrical AC areas through the power conversion stations of the MT-HVDC system. Dynamic active power sharing among power conversion station during transients is controlled through the use of different sets of parameters for the virtual shafts of the VMS controller, as described in Tables II and III for use cases B and C respectively. In this manner, FIG. 12B shows how Area 1 and Area 2 have higher active power sharing than Area 3 when the set of parameters of Case B is used. Similarly, FIG. 12C shows how Area 1 and Area 3 have higher active power sharing than Area 2 when the set of parameters of Case C is used. These results demonstrate the effectiveness of the VMS controller in regulating the dynamic active power sharing between different interconnected AC areas by just changing the set of parameters for the virtual shafts coupling the power stations of the system.

TABLE II
digital shaft model parameters for used case B

| | D₁₂ | K₁₂ | H₁₂ | D₁₃ | K₁₃ | H₁₃ |
|---|---|---|---|---|---|---|
| From Area 1 | 100 | 0.2 | 15 | 0.1 | 0.1 | 0.0 |
| | D₂₁ | K₂₁ | H₂₁ | D₂₃ | K₂₃ | H₂₃ |
| From Area 2 | 100 | 0.2 | 15 | 0.1 | 0.1 | 0.0 |
| | D₃₁ | K₃₁ | H₃₁ | D₃₂ | K₃₂ | H₃₂ |
| From Area 3 | 0.1 | 0.1 | 0.0 | 0.1 | 0.1 | 0.0 |

TABLE III
digital shaft model parameters for use case C.

| | D₁₂ | K₁₂ | H₁₂ | D₁₃ | K₁₃ | H₁₃ |
|---|---|---|---|---|---|---|
| From Area 1 | 0.1 | 0.1 | 0.0 | 10 | 0.2 | 1.0 |
| | D₂₁ | K₂₁ | H₂₁ | D₂₃ | K₂₃ | H₂₃ |
| From Area 2 | 0.1 | 0.1 | 0.0 | 0.1 | 0.1 | 0.0 |
| | D₃₁ | K₃₁ | H₃₁ | D₃₂ | K₃₂ | H₃₂ |
| From Area 3 | 10 | 0.2 | 1.0 | 0.1 | 0.1 | 0.0 |

A skilled person will be enabled by the present description and the accompanying figures to provide a computer program code for implementing the described functionalities without undue burden and without exercising inventive skill.

It should be understood that the detailed description of specific preferred embodiments is given by way of illustration only, since various changes and modifications within the scope of the invention will be apparent to the person skilled in the art. The scope of protection is defined by the following set of claims.

1. A control method for improving supply stability in a power network that electrically connects a first power converter to at least one second power converter through a power grid, the method comprising the steps of:
i) providing, for each pair of power converters composed of the first power converter and one of the second power converters, a digital shaft model of a mechanical shaft in a memory element, wherein said digital shaft model comprises a damping factor, an inertia and a stiffness of a mechanical shaft and emulates the electrical coupling between said pair of power converters through said power grid;
ii) obtaining, at a control unit, a pair of input signals from each of said pairs of power converters, wherein the input signals of a pair are indicative of rotating speeds applied to the ends of the corresponding digital shaft model;
iii) determining an active power deviation at the control unit, based on power transfers that are computed for each pair of power converters by applying a rotation equation to the corresponding digital shaft model using the corresponding pair of input signals; and
iv) at the control unit, communicating a reference signal to the first power converter, which allows the first power converter to feed the active power deviation into the power grid or to absorb the active power deviation from the power grid, depending on the positivity of the active power deviation.

2. The control method according to claim 1, wherein the step of obtaining a pair of input signals comprises obtaining at least one signal indicating a rotating speed from at least one second power converter, wherein said second power converter emulates a mass rotating at said rotating speed.

3. The control method according to claim 1, wherein the step of obtaining a pair of input signals comprises obtaining at least one measure of an AC grid frequency at the point of connection of at least one second power converter.

4. The control method according to claim 1, wherein the step of obtaining a pair of input signals comprises obtaining at least one measure of a DC voltage of a DC bus of at least one second power converter.

5. The control method according to claim 1, wherein said reference signal comprises an indication of an electrical current intensity to be injected by the first power converter into the electrical grid.

6. The control method according to claim 1, wherein the first power converter is controlled as a rotating mass, and wherein said reference signal comprises an indication of a load angle of the power converter.

7. The control method according to claim 1, wherein either the inertia or the stiffness, or both of the inertia and the stiffness of at least one digital shaft model are set to zero.

8. A control unit comprising:
a memory element in which digital shaft models are stored, each digital shaft model comprising a damping factor, an inertia and a stiffness of a mechanical shaft configured to emulate the electrical coupling between pairs of power converters electrically connected through a power grid, wherein each pair of power converters is composed of the same first power converter and one second power converter;
receiving means configured to receive a pair of input signals from each of said pairs of power converters, wherein the input signals of a pair are indicative of rotating speeds applied to the ends of the corresponding digital shaft model;
computing means configured to
determine an active power deviation, based on power transfers that are computed for each pair of power converters by applying a rotation equation to the corresponding digital shaft model using a corresponding obtained pair of input signals;
generate a reference signal, which allows the first power converter to feed the determined active power deviation into the power grid or to absorb the determined active power deviation from the power grid, depending on the positivity of the determined active power deviation;
transmission means configured to communicate said reference signal to the first power converter.

9. A control system comprising a plurality of control units in accordance with claim 8, wherein each control unit is configured to determine an active power deviation for one power converter of a plurality of power converters electrically interconnected through a power grid.

10. A power network in which a plurality of power converters are interconnected through a power grid, comprising at least one control unit in accordance with claim 8 for controlling at least one power converter.

11. The power network in accordance with claim 10, comprising a control system in accordance with claim 9.

12. A computer program comprising computer readable code means, which, when run on a computer system, causes the computer system to carry out the method according to claim 1.

13. The computer program according to claim 12, further comprising computer readable code means, which, when run on a computer system, causes the computer system to carry out the method according to claim 2.

14. A computer program product comprising a computer readable medium on which the computer program according to claim 12 is stored.
